(19) United States
(12) Patent Application Publication
(10) Pub. No.: US 2015/0114234 A1
(43) Pub. Date: Apr. 30, 2015

(54) DEVICE FOR IDENTIFICATION OF A FILTER HOLDER OF AN ESPRESSO COFFEE MACHINE

(71) Applicant: Gruppo Cimbali S.p.A., Binasco (IT)

(72) Inventor: Roberto Erba, Binasco (IT)

(21) Appl. No.: 14/526,115

(22) Filed: Oct. 28, 2014

(30) Foreign Application Priority Data
Oct. 28, 2013 (IT) MI2013A001791

(51) Int. Cl. G01J 5/10; A47J 31/24; G01J 5/08; A47J 31/44

(52) U.S. Cl. CPC G01J 5/10; A47J 31/446; A47J 31/24; G01J 5/0806
USPC 99/285

(57) ABSTRACT

A device for identification of a filter holder (4, 13) of an espresso coffee machine, comprising a support (3, 17, 18) on which the filter holder to be identified is removably placed, at least one thermopile radiation sensor (6, 6a) having a plurality of heat radiation-sensitive elements, an optical apparatus (8, 8a) that focuses radiations on said sensitive elements and circuit means, which receive electric signals transmitted by said sensitive elements and process a corresponding output signal. Said radiation sensor (6, 6a) is placed, relative to the support (3, 17, 18) for the filter holder to be identified, such that at least one portion thereof (10, 11, 15), when it is placed on the support, falls within the field of view (9, 9a) of the optical apparatus (8, 8a) of said sensor, such that said circuit means can determine a signal representative of the radiations of the filter holder portion detected by said optical apparatus of the sensor. According to the invention, the filter holder portion that is identified by the radiation sensor is a beverage dispensing spout portion of the filter holder.

### CROSS-REFERENCE TO RELATED APPLICATION

This application claims the benefit of Italian Patent Application No. MI2013A001791 filed on Oct. 28, 2013.

### BACKGROUND INFORMATION

The invention relates to a device for identification of a filter holder of an espresso coffee machine, comprising a support on which the filter holder to be identified is removably placed, said filter holder being provided with at least one beverage dispensing spout, at least one radiation sensor having at least one heat radiation-sensitive element, which is able to generate an electric signal representative of the heat radiation that has been sensed, an optical apparatus that focuses radiations on said at least one sensitive element and circuit means connected to said at least one heat radiation-sensitive element to receive the electric signals generated by said at least one sensitive element and process a corresponding output signal.

As is known, an espresso coffee machine is required to dispense various types of coffee-based beverages according to the tastes and traditions of various countries, requiring different amounts of coffee grounds or doses, possibly also with different grinding degrees or particle sizes.

It is also known that the filter holders of the machine are only loaded with coffee grounds by the operator during beverage preparation, by picking up the filter holder from its respective dispensing unit of the machine and placing it in its support located in the doser and grinder device.

In doing so, the operator has to select the particular filter holder, the type of blend and the dose, according to the requested type of beverage.

For example, if an Italian concentrated espresso coffee known as “ristretto” is requested, the operator shall use a single-cup filter holder, withdraw an appropriate dose of Italian roasted coffee, specially ground for Italian espresso, from the coffee grinder, introduce it into the machine at an espresso-calibrated dispenser, select dispensing of a small amount of water and finally use an adequate cup to collect the dispensed beverage.

If the request is for two moussy coffees known as “caffè crème”, a two-cup filter holder will be used, with a blonde roast coffee, specially ground for caffè crème, an amount of water required for two long doses, and large cups.

Considering that high-quality coffee bars may provide more than two varieties of coffee blends, the Italian espresso may be served in long or short shots, and machine dispensers dispense one or typically two coffees, it will be understood that, especially under intensive work conditions, the operator may take a wrong step and start dispensing a dose of caffè crème after mistakenly withdrawing a dose of coffee grounds for Italian espresso, or start dispensing two “ristrettos” after withdrawing two doses of blonde roast blends for caffè crème.

Therefore, it is important to determine whether one or two beverage dispensing spouts are present in the filter holder, i.e. to identify a single-dose or double-dose filter holder respectively.

The prior art provides various solutions to assist the operator in not mistaking the requested beverage type, such as those disclosed in EP-A-0280594, EP-A-2314188 or WO 2010130611A1.

In these prior art solutions, filter holders are identifiable by means of a mechanical, optical, magnetic or even radio label, which is identified by the ground coffee dose loading device or by a special dispenser of the coffee machine.

Nevertheless, the presence of a label on the filter holder, for identification thereof, causes drawbacks, as high mechanical and thermal stresses are involved when handling the filter holder.

In order to eject the spent grounds at the end of a dispensing operation, the filter holder is knocked against a wooden or rubber bar spanning over the box for spent grounds and, during operation, it is typically coupled to the dispenser unit of the machine, where temperatures range from 70 to 85° C.

Finally, it is washed daily, thereby receiving chemical and is thus exposed to chemical and abrasive stresses, which damage the labels on the filter holder.

Therefore, the object of the present invention is to provide a solution for identification of the filter holder of an espresso coffee machine that requires no label on the filter holder.

### SUMMARY OF THE INVENTION

This object is fulfilled by a device for the identification of a filter holder of an espresso coffee machine, comprising a support on which the filter holder to be identified is removably placed, at least one beverage delivering spout on the filter holder, at least one radiation sensor having at least one heat radiation-sensitive element suitable for generating an electric signal representative of the heat radiation detected by the sensitive element, an optical apparatus that focuses radiations on said at least one sensitive element of the radiation sensor, said optical apparatus having a predetermined field of view, circuit means connected to said at least one radiation sensitive element of the radiation sensor for receiving an electric signals generated by said at least one sensitive element and for processing a corresponding output signal, said radiation sensor being placed, relative to said support for the filter holder to be identified, in a position that, when the filter holder rests on the support, at least one portion of said at least one beverage delivering spout falls within the field of view of the optical apparatus of said sensor, the output signal processed by said circuit means being a signal representative of the radiation emitted by the spout portion detected by said optical apparatus of the sensor.

### BRIEF DESCRIPTION OF THE DRAWINGS

The invention will be now described in greater detail with reference to certain preferred embodiments thereof, given by way of illustration and without limitation, and shown in the annexed drawings, in which:

FIG. 1 shows a diagrammatic perspective view of a first embodiment of the device of the invention during identification of a double-dose filter holder with a double-spout outlet, the device being placed at a dispenser unit of an espresso coffee machine;

FIG. 2 shows a diagrammatic perspective view of the device of FIG. 1 during identification of a single-dose filter holder, with a single-spout outlet;

FIG. 3 shows a diagrammatic perspective view of a device of the invention according to its first embodiment, during identification of a single-dose filter holder with a single-spout outlet, the device being placed at the ground coffee loading area of a grinder-doser;

FIG. 4 shows a diagrammatic perspective view of a device of the invention according to a second embodiment, during identification of a double-dose filter holder with a double-spout outlet, the device being placed at the ground coffee loading area of a grinding and dosing apparatus;

FIG. 5 shows a diagrammatic perspective view of a device of the invention according to its second embodiment, during identification of a double-dose filter holder with a double-spout outlet, the device being placed at a dispenser unit of an espresso coffee machine;

FIG. 6 shows a diagrammatic perspective view of a device of the invention according to its second embodiment, during identification of a single-dose filter holder with a single-spout outlet, the device being placed at a dispenser unit of an espresso coffee machine;

FIG. 7 diagrammatically shows the functional parts of the radiation sensor as used in the embodiments of the invention;

FIG. 8 shows the type of indication given by the device of the invention in case of identification of a double-spout filter holder;

FIG. 9 shows the type of indication given by the device of the invention in case of identification of a single-spout filter holder.

### DETAILED DESCRIPTION

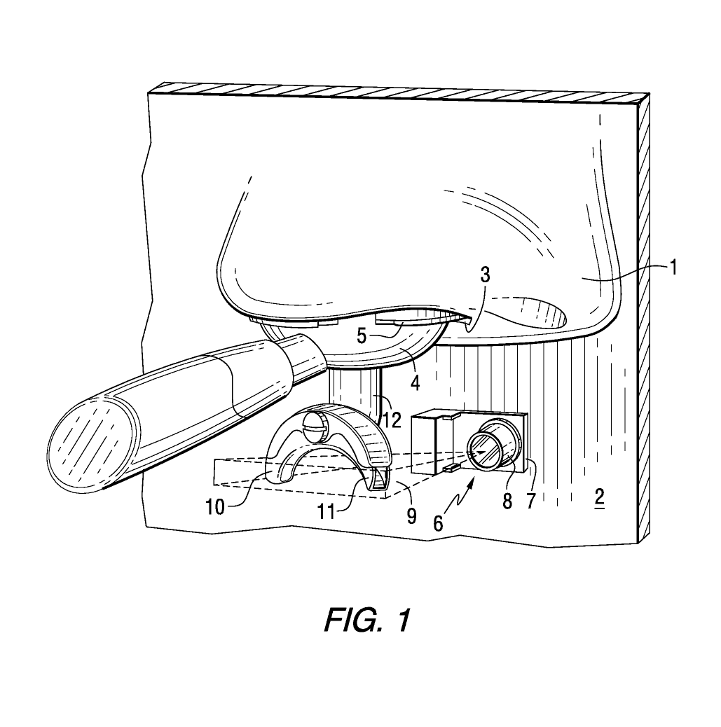

Referring to the above mentioned figures and particularly to FIG. 1, numeral 1 diagrammatically designates a traditional dispenser of an espresso coffee machine, with the wall from which the dispenser projects being designated by numeral 2.

The dispenser 1 comprises a support 3 with which a filter holder 4 engages.

The engagement of the filter holder 4 with the support 3 is conventionally obtained by means of wings 5 disposed at the periphery of the filter holder.

According to a first embodiment of the invention, the device comprises a thermopile heat radiation sensor, generally referenced 6, e.g. the sensor sold by EXCELITAS TECHNOLOGIES and known as TPiL 8T 2246 L3.9 OAA060 or an equivalent thereof, such as that disclosed in US 2013/0144563 A1

The sensor 6 is attached, for instance, to the wall 2 of the coffee machine that has the dispenser unit 1 fixed thereto.

Otherwise, the sensor 6 may be attached to a self-standing support, not shown.

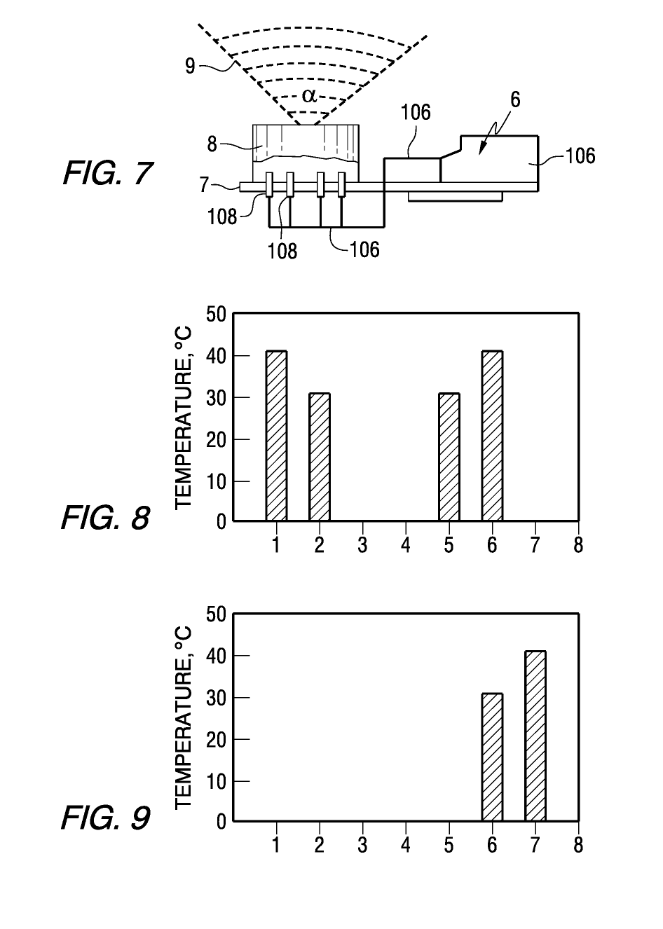

The sensor 6 is attached to the wall 2, for example, through the terminal block 7 of the sensor, which has thereon the optical apparatus 8 that focuses the heat radiation emitted from the filter holder to be identified on sensitive elements, referenced 108, placed on the same terminal block 7 of the sensor 6 (see FIG. 7).

Also the circuit means, referenced 106 (see FIG. 7) which are connected to the elements 108 and receive the electric signals transmitted therefrom and process corresponding output signals, may be housed on the same terminal block 7 of the sensor 6.

According to the invention, the terminal block 7 is placed in such position that the optical apparatus 8 turns its detection cone 9 toward the spouts 10 and 11 of the outlet 12 of the filter holder.

In the case of FIG. 1, a conventional filter holder is shown which must contain a double dose of ground coffee for use, and hence has two beverage dispensing spouts.

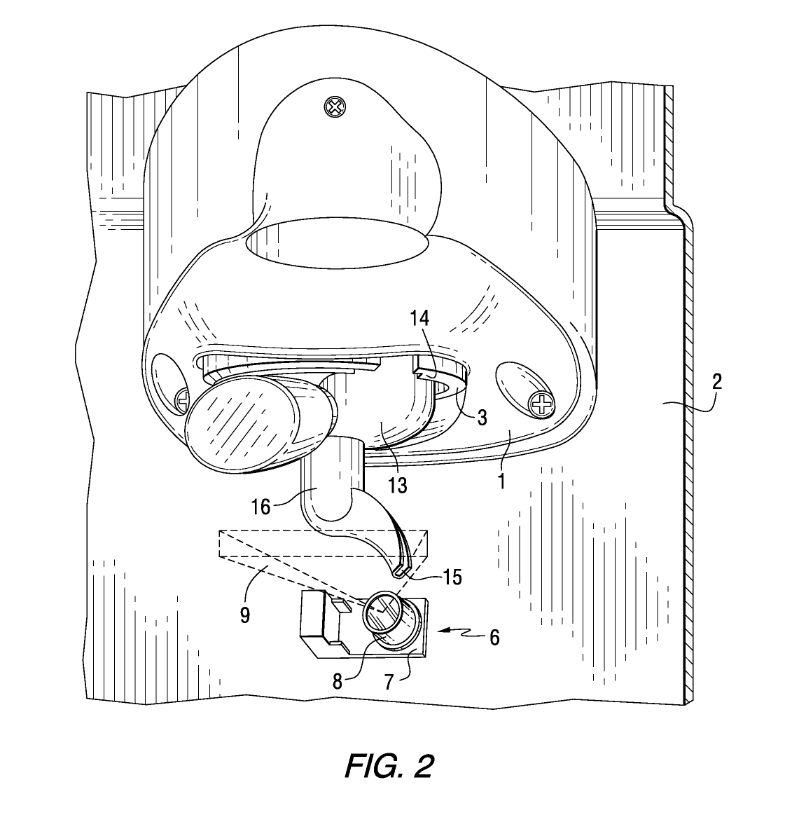

Referring to FIG. 2, in which structural elements corresponding to those of FIG. 1 are designated by the same numerals, the filter holder 13, with its wings 14 for engagement with the support 3 of the dispenser 1, has a single spout 15 branching off the outlet 16.

Therefore, this filter holder must contain a single dose of ground coffee for use.

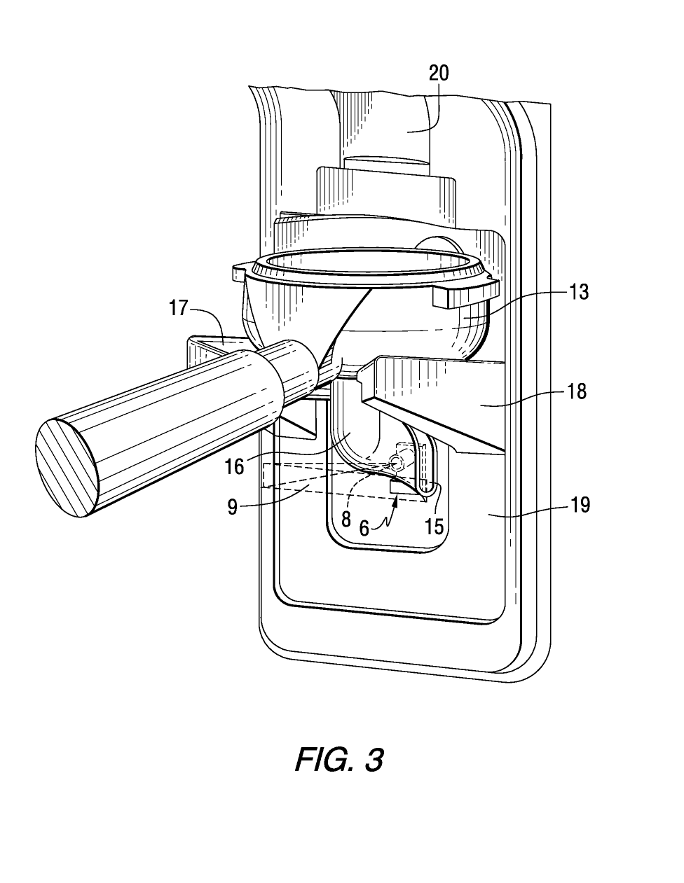

Referring to FIG. 3, the device of the invention comprises, as a support for the filter holder to be identified, a pair of brackets 17 and 18 which project out of the wall 19 of a grinding and dosing apparatus whose ground coffee outlet is schematically referenced 20.

The filter holder as shown in FIG. 3 corresponds to the single-dose filter holder 13 of FIG. 2, with a single beverage dispensing spout 15, during beverage preparation.

Under the support consisting of the brackets 17 and 18 of the grinding and dosing apparatus, the device comprises a sensor 6.

The cone of vision 9 of the latter is turned toward the filter holder 13 to intercept the body of the spout 15.

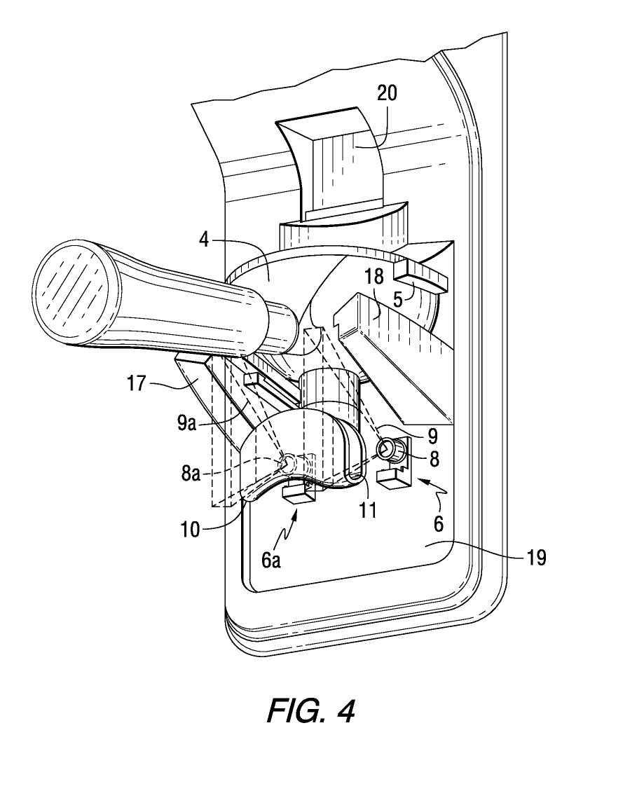

Referring to FIG. 4 and according to a second embodiment of the invention, in case of attachment to a coffee grinding and dosing apparatus, the filter holder identification device comprises, under the brackets 17 and 18 for supporting the filter holder, two heat radiation sensors, referenced 6 and 6a, whose optical apparatus 8 and 8a, with their respective conical heat radiation detection fields, intercept respective outlet spouts 10 and 11 of the outlet 12 of the filter holder 4 which, in the example of FIG. 4, is of the double-dose type, like that of FIG. 1.

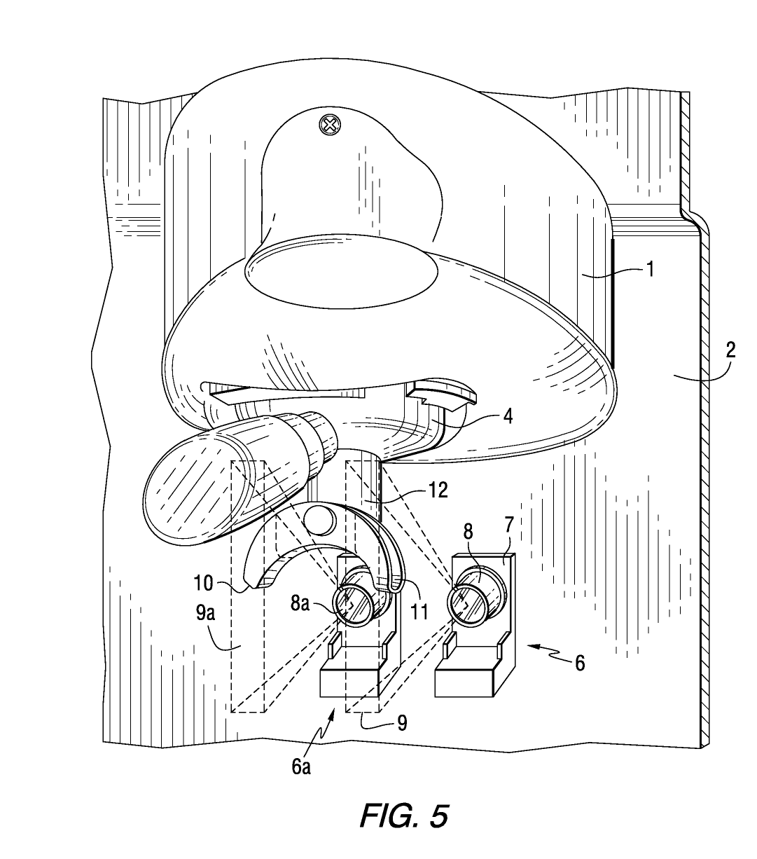

Referring to FIG. 5 and according to the second embodiment of the invention, the filter holder identification device comprises two heat radiation sensors, referenced 6 and 6a respectively, which are attached to the wall 2 of an espresso coffee machine beneath a dispenser 1, with the respective conical detection fields 9 and 9a of the optical apparatus 8 and 8a turned toward the spout 10 and the spout 11 respectively of the filter holder 4 which, in FIG. 5, corresponds to the that with two spouts 10 and 11 as shown in FIG. 1.

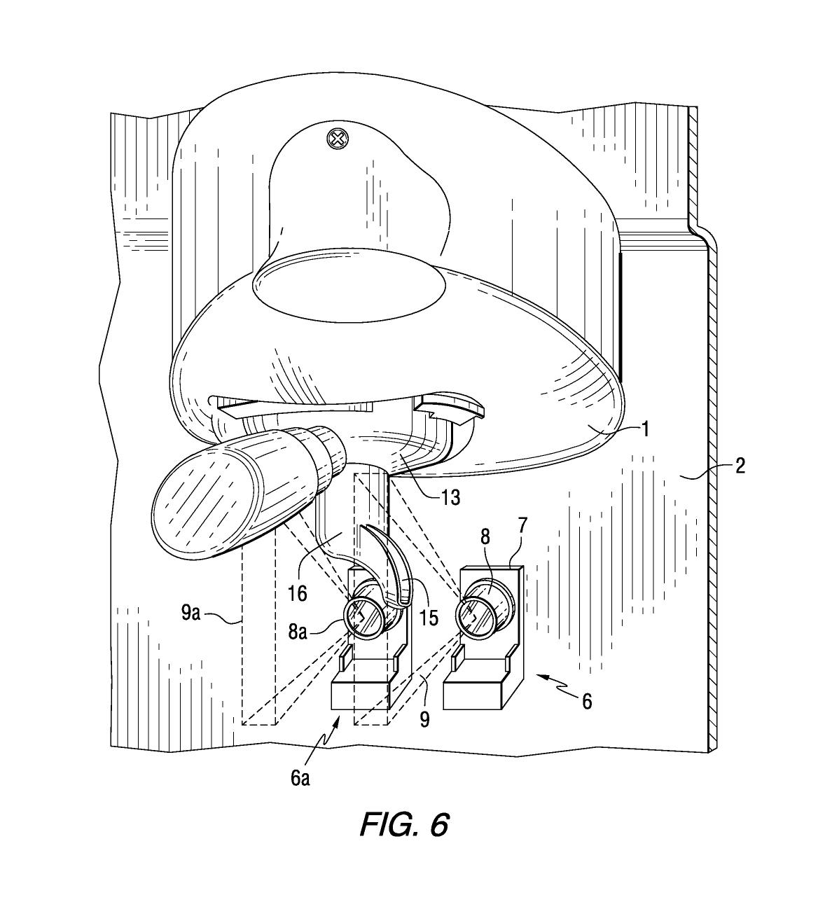

Referring now to FIG. 6, a device according to the second embodiment of the invention as shown in FIG. 5 is exemplified during identification of a filter holder 13 with a single spout 15, associated with a dispenser 1 of an espresso coffee machine.

It will be appreciated from the above that the device of the invention may be used to identify a type of filter holder even when the latter has no label thereon.

As shown in FIG. 7, the device of the invention according to its first embodiment, can use the sensor 6 to sense the temperature of the filter holder spouts, which fall within the field of view 9, having an aperture angle a, of its optical apparatus 8, and to release information, as electric signals proportional to the temperature of the spouts, while also showing their spatial arrangement in said field of view 9, which obviously depends on whether one or two spouts are provided.

The signals emitted from the sensor 6 are processed by an electronic unit which generates a representation. e.g. a bar graph, of a double-spout filter holder as shown in FIG. 8, or a single-spout filter holder, as shown in the graph of FIG. 9.

These signals, which provide identification of the filter holder type, in case of attachment to a grinding and dosing apparatus, can instruct the latter to load the filter holder with the appropriate dose of ground coffee.

If the device of the invention is attached to a dispenser of an espresso coffee machine, the same filter holder identification signals will be used to automatically supply the proper amount of hot water to the dispenser, such that the filter holders receive the proper dose of water, according to their types, without risking that a wrong control imparted by the operator may lead to a wrong dose administration.

The signals emitted from the sensors 6, which are also indicative of the temperature at the filter holder spouts, may be also employed to prevent hot water dispensing, and hence beverage preparation, if an insufficient temperature is found in the filter holder spouts, to indicate that the filter holder is too cold, which might affect the quality of the dispensed beverage.

Nevertheless, the magnitude of the signals emitted from the sensor shall also be accounted for when designing the device, because it also depends on the amount of heat radiations emitted from the filter holder body, which in turn depends on the degree of reflection of the outer surface of the filter holder, on its color and the material of which it is made.

The operation and purposes of the device according to the second embodiment of the invention do not differ from those described with reference to the first embodiment.

Since the field of view 9 of the optical apparatus 8 of the sensor 6 is characterized by a given angle a, geometric positioning constraints apply, for the filter holder spouts to be identified to entirely fall within such field of view.

If a new apparatus is designed, these requirements of the device may be accounted for, such that the sensor holding structure 6 and the filter holder support may be properly designed for the use of a single sensor 6, like in the case of the first embodiment of the invention.

In case of use with existing apparatus or with apparatus that require particular geometries for the filter holder support structure, an identification device comprising a pair of sensors 6 and 6a, like in the second embodiment of the invention, may be technically more advantageous.

Of course, the filter holder identification signals obtained with the device of the invention may be used to exchange filter holder type information between different machines, such as a grinding and dosing apparatus and an espresso coffee machine, by sending information to the latter about the type of filter holder that has been loaded and preventing delivery of doses of hot water for beverage preparation other than the proper one for the dose contained in the filter holder when the latter is introduced into the dispensers of the coffee machine.

While the filter holder identification device has been described above with exemplary reference to incorporation thereof in a coffee grinding and dosing apparatus and in an espresso coffee machine, it may be obviously provided as a self-standing structure, separate both from the grinding and dosing apparatus and from the coffee machine, and able to interact with them by sending a signal corresponding to the identified filter holder type to either or both of them.

What is claimed is:

1. A device for the identification of a filter holder of an espresso coffee machine, comprising a support on which the filter holder to be identified is removably placed, at least one beverage delivering spout on the filter holder, at least one radiation sensor having at least one heat radiation-sensitive element suitable for generating an electric signal representative of the heat radiation detected by the sensitive element, an optical apparatus that focuses radiations on said at least one sensitive element of the radiation sensor, said optical apparatus having a predetermined field of view, a circuit connected to said at least one radiation sensitive element of the radiation sensor for receiving an electric signals generated by said at least one sensitive element and for processing a corresponding output signal, said radiation sensor being placed, relative to said support for the filter holder to be identified, in a position that, when the filter holder rests on the support, at least one portion of said at least one beverage delivering spout falls within the field of view of the optical apparatus of said sensor, the output signal processed by said circuit being a signal representative of the radiation emitted by the spout portion detected by said optical apparatus of the sensor.

2. A device according to claim 1, wherein said filter holder is a double-dose filter holder and comprises two beverage delivery spouts.

3. A device according to claim 1, wherein said filter holder is a single-dose filter holder and comprises one beverage delivery spout.

4. A device according to claim 1, comprising two radiation sensors, each sensor being placed, relative to the support for the filter holder to be identified, in a position that, when the filter holder rests on the support, respective portions of the at least one beverage delivery spout thereof fall within the field of view of the optical apparatus of a respective sensor of said two radiation sensors.

5. A device according to claim 1, wherein said sensor comprises a plurality of heat radiation-sensitive elements.

6. A device according to claim 1, wherein said at least one radiation-sensitive element is of the thermopile type.

7. A device according to claim 1, wherein said support for the filter holder to be identified is placed at the ground coffee dispensing outlet of a coffee grinding and dosing apparatus.

8. A device according to claim 1, wherein said support for the filter holder to be identified is placed at a dispenser of an espresso coffee machine for beverage preparation.
